(19) United States
(12) Patent Application Publication
(10) Pub. No.: US 2024/0298364 A1
(43) Pub. Date: Sep. 5, 2024

(54) WIRELESS COMMUNICATION DEVICE AND WIRELESS COMMUNICATION SYSTEM

(71) Applicant: FUJITSU LIMITED, Kawasaki-shi Kanagawa (JP)

(72) Inventors: Yoshiaki OHTA, Yokohama (JP); SHINICHIRO AIKAWA, Yokohama (JP); YOSHIHIRO KAWASAKI, Kawasaki (JP)

(73) Assignee: FUJITSU LIMITED, Kawasaki-shi Kanagawa (JP)

(21) Appl. No.: 18/629,161

(22) Filed: Apr. 8, 2024

Related U.S. Application Data
(63) Continuation of application No. PCT/JP2021/038608, filed on Oct. 19, 2021.

(51) Int. Cl. H04W 76/10; H04W 60/04; H04W 76/30

(52) U.S. Cl. CPC H04W 76/10; H04W 60/04; H04W 76/30

(57) ABSTRACT

A wireless communication device includes processor circuitry configured to perform to control, when establishing communication with another wireless communication device in a non-communication mode, to generate first identification information included in identification information that is able to simultaneously identify the wireless communication device itself and the other wireless communication device, regardless of whether the other wireless communication device holds second identification information included in the identification information, and to notify the generated first identification information to the other wireless communication device.

### CROSS-REFERENCE TO RELATED APPLICATION

This application is a continuation of International Application No. PCT/JP2021/038608, filed on Oct. 19, 2021, the entire contents of which are incorporated herein by reference.

### FIELD

The embodiments discussed herein are related to a wireless communication device and a wireless communication system.

### BACKGROUND

In general, Radio Resource Control (RRC) layer processing is executed in wireless communication systems. In the RRC layer processing, configuration, modification, release, and the like of connection are executed between a base station device and a terminal device, for example. For example, in Long Term Evolution (LTE) or LTE-Advanced (LTE-A) as the standard technology for 4G, RRC Connected mode (RRC_CONNECTED) and RRC idle mode (RRC_IDLE) are defined as the states of the RRC layer. The RRC connected mode, for example, is a mode in which data communication can be performed between the base station device and the terminal device. The RRC idle mode is, for example, a mode in which data communication is not performed between the base station device and the terminal device, and in which the terminal device is in a power-saving state.

In 5th generation mobile communication (5G or New Radio (NR)), RRC inactive mode (RRC_INACTIVE) is introduced in addition to the RRC connected mode and the RRC idle mode. The RRC inactive mode is a low-power consumption mode equivalent to the RRC idle mode, and it is able to quickly transit to the RRC connected mode when transmitting data. In the RRC inactive mode, a context of the terminal device (hereinafter referred to as “UE context”) is held in the base station device. The UE context is identification information that identifies information regarding the terminal device, such as location, communication capabilities, and various parameters of the terminal device. As described, since the UE context is held in the base station device, it is considered by the core network that the terminal device is being connected to the base station device even in the RRC inactive mode. As a result, when the terminal device returns from the RRC inactive mode to the RRC connected mode, signal transmission and reception between the base station device and the core network are omitted, thereby achieving quick transition to the RRC connected mode. The related technologies are described, for example, in: Japanese National Publication of International Patent Application No. 2020-512762; Japanese National Publication of International Patent Application No. 2019-535201; 3GPP TS36.133 V17.1.0 (2021 March); 3GPP TS36.211 V16.5.0 (2021 March); 3GPP TS36.212 V16.5.0 (2021 March); 3GPP TS36.213 V16.5.0 (2021 March); 3GPP TS36.214 V16.2.0 (2021 March); 3GPP TS36.300 V16.5.0 (2021 March); 3GPP TS36.321 V16.4.0 (2021 March); 3GPP TS36.322 V16.0.0 (2020 July); 3GPP TS36.323 V16.3.0 (2020 December); 3GPP TS36.331 V16.4.0 (2021 March); 3GPP TS36.413 V16.5.0 (2021 April); 3GPP TS36.423 V16.5.0 (2021 April); 3GPP TS36.425 V16.0.0 (2020 July); 3GPP TS37.324 V16.2.0 (2020 September); 3GPP TS37.340 V16.5.0 (2021 March); 3GPP TS38.201 V16.0.0 (2019 December); 3GPP TS38.202 V16.2.0 (2020 September); 3GPP TS38.211 V16.5.0 (2021 March); 3GPP TS38.212 V16.5.0 (2021 March); 3GPP TS38.213 V16.5.0 (2021 March); 3GPP TS38.214 V16.5.0 (2021 March); 3GPP TS38.215 V16.4.0 (2020 December); 3GPP TS38.300 V16.5.0 (2021 March); 3GPP TS38.321 V16.4.0 (2021 March); 3GPP TS38.322 V16.2.0 (2020 December); 3GPP TS38.323 V16.3.0 (2021 March); 3GPP TS38.331 V16.4.1 (2021 March); 3GPP TS38.401 V16.5.0 (2021 April); 3GPP TS38.410 V16.3.0 (2020 September); 3GPP TS38.413 V16.5.0 (2021 April); 3GPP TS38.420 V16.0.0 (2020 July); 3GPP TS38.423 V16.5.0 (2021 April); 3GPP TS38.470 V16.4.0 (2021 April); 3GPP TS38.473 V16.5.0 (2021 April); 3GPP TR38.801 V14.0.0 (2017 March); 3GPP TR38.802 V14.2.0 (2017 September); 3GPP TR38.803 V14.2.0 (2017 September); 3GPP TR38.804 V14.0.0 (2017 March); 3GPP TR38.900 V15.0.0 (2018 June); 3GPP TR38.912 V16.0.0 (2020-07); and 3GPP TR38.913 V16.0.0 (2020 July).

By the way, for example, when a terminal device moves during the RRC inactive mode and returns to the RRC connected mode within a communication range of a different base station device, the destination base station device requests and acquires a UE context from the source base station device (referred to as “anchor” base station, for example). Then, the destination base station device restarts communication with the terminal device using the UE context acquired from the source base station device. Similarly, when a higher-level device in the core network under control is changed due to the movement of the terminal device, for example, the destination higher-level device acquires the UE context from the source higher-level device.

### SUMMARY

According to an aspect of an embodiment, a wireless communication device includes a processor. The processor is configured to perform to control, when establishing communication with another wireless communication device in a non-communication mode, to generate first identification information included in identification information that is able to simultaneously identify the wireless communication device itself and the other wireless communication device, regardless of whether the other wireless communication device holds second identification information included in the identification information, and to notify the generated first identification information to the other wireless communication device.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a diagram illustrating a configuration example of a wireless communication system according to a first embodiment;

FIG. 2 is a diagram illustrating a configuration example of a wireless communication system according to a second embodiment;

FIG. 3 is a block diagram illustrating a configuration of a base station device;

FIG. 4 is a block diagram illustrating a configuration of a terminal device;

FIG. 5 is a sequence chart illustrating an information management method according to the second embodiment;

FIG. 6 is a sequence chart illustrating a specific example of a context registration procedure;

FIG. 7 is a sequence chart illustrating paging processing;

FIG. 8 is a sequence chart illustrating an information management method according to a third embodiment; and

FIG. 9 is a sequence chart illustrating a specific example of movement of the terminal device.

### DESCRIPTION OF EMBODIMENTS

However, such a UE context management method described above causes communication delays due to searching and the like of the UE context, which results in low adaptability. That is, for example, when a terminal device in the RRC inactive mode moves across base station devices or higher-level devices, the base station device or higher-level device at the destination searches for a base station device or higher-level device that holds the UE context and acquires the UE context from the base station device or higher-level device searched out. Thus, when the terminal device returns to the RRC connected mode under control of the base station device or higher-level device at the destination, there is a delay generated until the terminal device returns to the RRC connected mode and starts communication.

Furthermore, when the UE context is transferred, signaling related to the transfer of the UE context occurs between the base station device or higher-level device at the destination and the base station device or higher-level device at the source, and the processing load of the base station devices and the higher-level devices increases as the signaling increases. Thus, the UE context management method as described above has a problem with low adaptability to various situations because communication delays occur and the processing load increases when, for example, a situation such as movement of the terminal device occurs.

Preferred embodiments of the present disclosure will be explained with reference to accompanying drawings. Note that the present disclosure is not limited by the embodiments.

### a First Embodiment

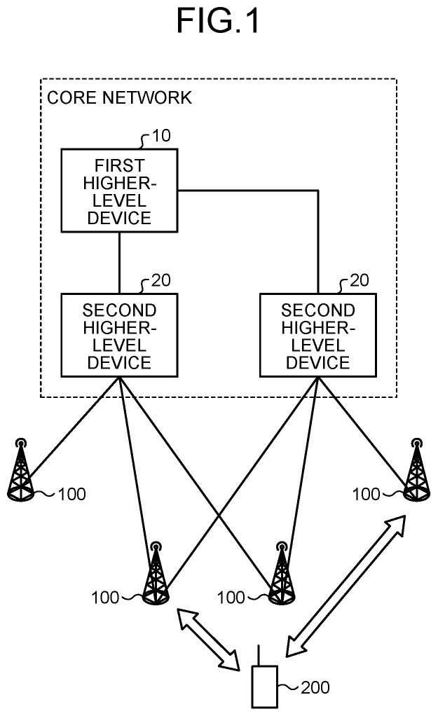

FIG. 1 is a diagram illustrating a configuration example of the wireless communication system according to a first embodiment. The wireless communication system illustrated in FIG. 1 includes a plurality of base station devices 100 connected to a core network, and a terminal device 200. Furthermore, the core network includes a first higher-level device 10 and second higher-level devices 20.

The first higher-level device 10 manages sessions related to communication of the terminal device 200. The second higher-level device 20 manages the security and location of the terminal device 200. A plurality of second higher-level devices 20 are disposed in the core network, and each of the second higher-level devices 20 accepts registration of a UE context for each Subscriber Identity Module (SIM) of the terminal device 200 and holds the registered UE context. Therefore, a plurality of UE contexts can be registered in the core network for the SIM of a single terminal device 200.

Each of the base station devices 100 is a wireless communication device that is connected to the core network and can communicate wirelessly with the terminal device 200 located within the communication range. Although omitted in the drawings, the base station devices 100 are connected to each other by, for example, X2 interface, Xn interface, or the like. When establishing communication with the terminal device 200 in, for example, a non-communication mode such as RRC inactive mode, the base station device 100 can generate a UE context of the terminal device 200 and sends a notification regarding the UE context to the terminal device 200, regardless of whether the terminal device 200 already holds a UE context. That is, the base station device 100 can generate a UE context and send a notification to the terminal device 200, regardless of whether a notification of a UE context is already sent from another base station device 100 to the terminal device 200. The base station device 100 also holds the UE context related to the notification to the terminal device 200. Thus, for the SIM of a single terminal device 200, a plurality of UE contexts can be held by a plurality of base station devices 100.

The UE context held by the base station device 100 regarding the terminal device 200 is identified by identification information that can simultaneously identify the base station device 100 and the terminal device 200. As such identification information, Inactive-Radio Network Temporary Identifier (I-RNTI) can be used, for example. As described, since the UE context can be identified by I-RNTI, for example, it is possible to uniquely specify each of a plurality of UE contexts for the SIM of a single terminal device 200.

The terminal device 200 is a wireless communication device capable of having wireless communication with the base station device 100. The terminal device 200 can operate by switching between a communication mode such as the RRC connected mode and a non-communication mode such as the RRC inactive mode, for example. When establishing communication with the base station device 100 in a non-communication mode, the terminal device 200 can be notified of the identification information of the UE context generated by the base station device 100, regardless of whether the terminal device 200 already holds the UE context. That is, the terminal device 200 can hold the identification information of the UE context notified from a new base station device 100, regardless of whether the identification information of the UE context is already notified from another base station device 100.

When the terminal device 200 connects to a first base station device 100, the first base station device 100 generates identification information of a UE context that can simultaneously identify the terminal device 200 and the first base station device 100, and notifies the identification information to the terminal device 200 while holding the UE context. The terminal device 200 holds the identification information of the UE context notified from the first base station device 100.

Then, when the terminal device 200, for example, moves and connects to a second base station device 100, the second base station device 100 can generate identification information of a UE context that can simultaneously identify the terminal device 200 and the second base station device 100 and notify the identification information to the terminal device 200 while holding the UE context, regardless of whether the terminal device 200 already holds the identification information of the UE context. The terminal device 200 can hold the identification information of the UE context notified from the second base station device 100.

As described above, according to the present embodiment, when a terminal device connects to a base station device or a higher-level device, identification information of a UE context can be generated and notified to the terminal device, regardless of whether identification information of a UE context is already held. In other words, for the SIM of a single terminal device, a plurality of UE contexts can be held by a plurality of base station devices, and the identification information of those UE contexts is notified to the terminal device. Therefore, even in a case where a terminal device connects to a plurality of base station devices or higher-level devices, there is no need to transfer the UE context when communicating with the terminal device because each of the base station device or higher-level devices holds the UE context. Thus, it is possible to improve adaptability to various situations.

### b Second Embodiment

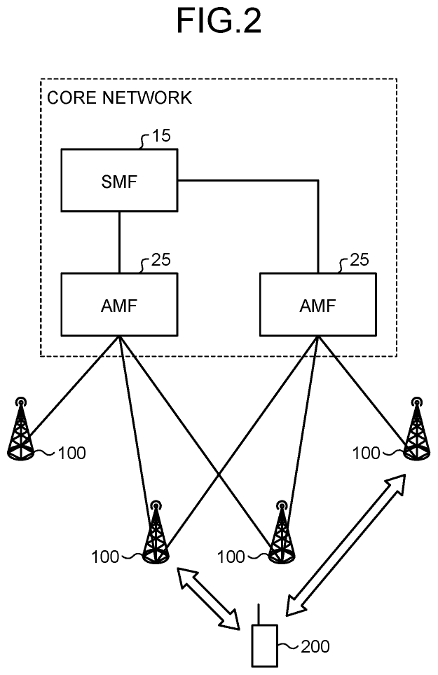

FIG. 2 is a diagram illustrating a configuration example of a wireless communication system according to a second embodiment. In FIG. 2, the same reference signs are applied to the same structural components as those of FIG. 1. The wireless communication system illustrated in FIG. 2 includes a plurality of base station devices 100 connected to a core network, and a terminal device 200. Furthermore, the core network includes a Session Management Function (SMF) 15 and Access and Mobility management Functions (AMFs) 25.

The SMF 15 manages sessions related to communication of the terminal device 200. Specifically, when downlink data (hereinafter abbreviated as “DL data”) addressed to the terminal device 200 is generated, the SMF 15 notifies the AMF 25 that DL data is generated.

The AMF 25 manages the security and location of the terminal device 200. Each AMF 25 accepts registration of the UE context for each SIM of the terminal device 200 and holds the registered UE context. Furthermore, when notified by the SMF 15 that DL data is generated, the AMF 25 executes paging to call the terminal device 200 that is the destination of the DL data.

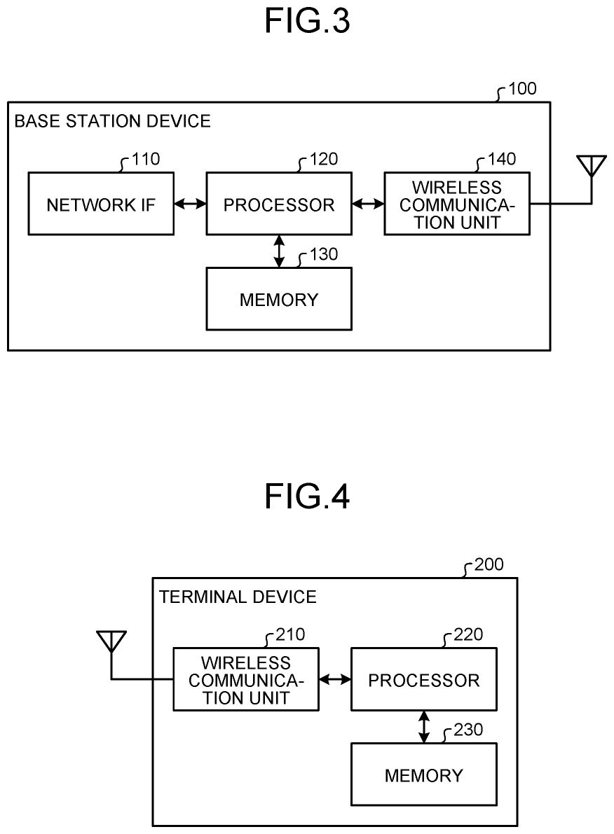

FIG. 3 is a block diagram illustrating the configuration of the base station device 100 according to the second embodiment. The base station device 100 illustrated in FIG. 3 includes a network interface (hereinafter abbreviated as “network IF”) 110, a processor 120, a memory 130, and a wireless communication unit 140.

The network IF 110 is connected to the core network over wireline, and transmits and receives signals to and from, for example, devices such as the AMF 25 that configure the core network.

The processor 120 includes, for example, a central processing unit (CPU), a field programmable gate array (FPGA), a digital signal processor (DSP), and the like, and executes overall control of the entire base station device 100. When establishing communication with the terminal device 200 in, for example, a non-communication mode such as the RRC inactive mode, the processor 120 can generate a UE context of the terminal device 200 and notify identification information of the UE context to the terminal device 200, regardless of whether the terminal device 200 already holds identification information of the UE context. That is, the processor 120 can generate a UE context and notify the identification information of the new UE context to the terminal device 200, regardless of whether the identification information of the UE context is already notified from another base station device 100 to the terminal device 200.

The memory 130 includes, for example, a Random Access Memory (RAM) or a Read Only Memory (ROM), and the like, and stores information used for processing performed by the processor 120.

The wireless communication unit 140 executes wireless communication with an opposing terminal device 200. The wireless communication unit 140 transmits the identification information of the UE context generated by the processor 120, for example, to the terminal device 200. The wireless communication unit 140 also receives data transmitted from the terminal device 200. Note that the wireless communication unit 140 can perform prescribed communication with the terminal device 200, even when the opposing terminal device 200 is in a non-communication mode.

FIG. 4 is a block diagram illustrating the configuration of the terminal device 200 according to the second embodiment. The terminal device 200 illustrated in FIG. 4 includes a wireless communication unit 210, a processor 220, and a memory 230.

The wireless communication unit 210 executes wireless communication with an opposing base station device 100. The wireless communication unit 210 transmits and receives various signals to and from the base station device 100 for switching the communication mode and non-communication mode of the terminal device 200. For example, the wireless communication unit 210 receives the identification information of the UE context notified from the base station device 100, when the terminal device 200 establishes communication with the base station device 100. Note that the wireless communication unit 210 can perform prescribed communication with the base station device 100, even when the terminal device 200 is in a non-communication mode.

The processor 220 is a control unit that includes, for example, a CPU, an FPGA, a DSP, and the like, and performs overall control of the entire terminal device 200. The processor 220 also switches the mode of the terminal device 200 between a communication mode such as the RRC connected mode and a non-communication mode such as the RRC inactive mode, for example. When establishing communication with the base station device 100 in a non-communication mode, the processor 220 can be notified of the identification information of the UE context generated by the base station device 100, regardless of whether the terminal device 200 already holds the identification information of the UE context. That is, the processor 220 holds the identification information of the UE context notified from a new base station device 100, regardless of whether the identification information of the UE context is already notified from another base station device 100.

The memory 230 includes, for example, a RAM or a ROM, and the like, and stores information used for processing performed by the processor 220.

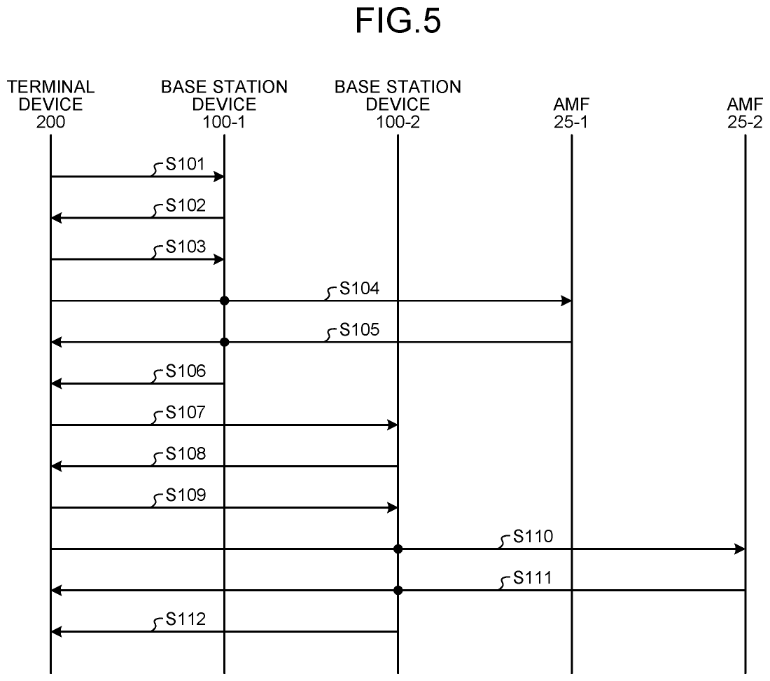

Next, an information management method performed by the wireless communication system configured as described above will be explained by referring to FIG. 5. In the following description, it is assumed that the wireless communication system includes base station devices 100-1 and 100-2 having the configuration equivalent to that of the base station device 100, and AMFs 25-1, 25-2 having the configuration equivalent to that of the AMF 25.

When the terminal device 200 establishes communication with the base station device 100-1, an access layer (Access Stratum: AS) message (hereinafter referred to as “AS message”) for requesting connection is transmitted from the terminal device 200 to the base station device 100-1 (step S101). Examples of the AS message include an RRC connection request (Connection Request), a connection resume request (Connection Resume Request), and the like.

In response to the AS message, an AS message for prescribed configurations is transmitted from the base station device 100-1 to the terminal device 200 (step S102), and an AS message for notifying completion of connection is transmitted from the terminal device 200 to the base station device 100-1 (step S103).

When connection between the terminal device 200 and the base station device 100-1 is established in this manner, a non-access layer (Non-Access Stratum: NAS) message (hereinafter referred to as “NAS message”) for registration (for example, location registration) is transmitted from the terminal device 200 to the AMF 25-1 that has control over the base station device 100-1 via the base station device 100-1 (step S104). When the UE context of the terminal device 200 is registered by the AMF 25-1, a NAS message indicating that the registration has been accepted is transmitted from the AMF 25-1 to the terminal device 200 via the base station device 100-1 (step S105).

Furthermore, in the base station device 100-1, a UE context regarding the terminal device 200 is generated. Then, temporary identification information including the identification information of the terminal device 200 and the identification information of the base station device 100-1 is generated as the identification information of the UE context. As the temporary identification information, it is possible to use I-RNTI, for example. I-RNTI is 40-bit identification information that can simultaneously identify the terminal device and the base station device. That is, I-RNTI can be expressed as follows.

I-RNTI=Identification information of base station device+Identification information of terminal device

Since I-RNTI is 40-bit identification information, when the number of bits allocated to the identification information of the base station is increased, the number of base stations that can be identified increases while the number of terminal devices that can be identified decreases. On the other hand, when the number of bits allocated to the identification information of the base station is decreased, the number of the base stations that can be identified decreases while the number of terminal devices that can be identified increases.

The generated UE context is held by the base station device 100-1, and the identification information of the UE context is notified to the terminal device 200 by, for example, an AS message for releasing the connection (step S106). Upon receiving the notification, the terminal device 200 holds the identification information of the UE context and releases the connection with the base station device 100-1. At this time, the terminal device 200 may transition to the RRC inactive mode, for example.

Then, the terminal device 200, for example, moves and establishes communication with the base station device 100-2, an AS message for requesting connection is transmitted from the terminal device 200 to the base station device 100-2 (step S107). In response to the AS message, an AS message for prescribed configurations is transmitted from the base station device 100-2 to the terminal device 200 (step S108), and an AS message for notifying completion of connection is transmitted from the terminal device 200 to the base station device 100-2 (step S109).

Here, even though the terminal device 200 according to the present embodiment already holds the identification information of the UE context notified from the base station device 100-1, it does not send a notification regarding the UE context held therein to the base station device 100-2 when establishing connection with the base station device 100-2. That is, the terminal device 200 can establish connection with the base station device 100-2 in the same procedure used when establishing connection with the base station device 100-1, regardless of whether the terminal device 200 already holds the identification information of the UE context. Similarly, the terminal device 200 according to the present embodiment is already registered (for example, location registration) in the AMF 25-1, but does not notify the information for specifying the AMF 25-1 to the base station device 100-2. That is, the terminal device 200 can establish connection with the base station device 100-2 in the same procedure used when establishing connection with the base station device 100-1, regardless of whether the UE context is already registered in the AMF 25-1.

When connection between the terminal device 200 and the base station device 100-2 is established in this manner, a NAS message for registration (for example, location registration) is transmitted from the terminal device 200 to the AMF 25-2 that has control over the base station device 100-2 via the base station device 100-2 (step S110). When the UE context of the terminal device 200 is registered by the AMF 25-2, a NAS message indicating that the registration has been accepted is transmitted from the AMF 25-2 to the terminal device 200 via the base station device 100-2 (step S111).

Furthermore, in the base station device 100-2, a UE context regarding the terminal device 200 is generated. That is, the base station device 100-2 can generate temporary identification information including the identification information of the terminal device 200 and the identification information of the base station device 100-2 as the identification information of the UE context, regardless of whether the terminal device 200 already holds the identification information of the UE context. As the temporary identification information, it is possible to use I-RNTI, for example, like the identification information generated by the base station device 100-1.

The generated UE context is held by the base station device 100-2, and the identification information of the UE context is notified to the terminal device 200 by, for example, an AS message for releasing the connection (step S112). Upon receiving the notification, the terminal device 200 holds the identification information of the UE context and releases the connection with the base station device 100-2. At this time, the terminal device 200 may transition to the RRC inactive mode, for example.

As described, when the terminal device 200 establishes communication with the base station device 100-2, the terminal device 200 acquires and holds the identification information of the UE context anew from the base station device 100-2 even when the terminal device 200 already holds the identification information of the UE context notified from the base station device 100-1. The base station device 100-2 can also generate a new UE context and notify the identification information of the new UE context even when the terminal device 200 already holds the identification information of the UE context notified from the base station device 100-1. Furthermore, the AMF 25-2 can register a new UE context even when the UE context of the terminal device 200 is already registered in the AMF 25-1. Thus, for example, even when the terminal device 200 in the RRC inactive mode moves from the communication range of the base station device 100-1 to the communication range of the base station device 100-2 and returns to the RRC connected mode, there is no need to transfer the UE context between the base station devices or the AMFs. As a result, it is possible to suppress the communication delays when the terminal device 200 returns to the RRC connected mode and to reduce the processing load caused due to signaling related to the transfer of the UE context. In other words, it is possible to improve the adaptability to various situations.

Note that generation of the UE context by the base station devices 100-1 and 100-2 or registration of the UE context by the AMFs 25-1 and 25-2 is not executed only when the terminal device 200 moves. For example, even when the terminal device 200 stays, a UE context may be generated by each of the base station devices 100-1 and 100-2 to which the terminal device 200 can be connected, and the UE context may be registered in each of the AMFs 25-1 and 25-2. That is, the processing of steps S101 to S106 and steps S107 to S112 illustrated in FIG. 5 can be executed in parallel.

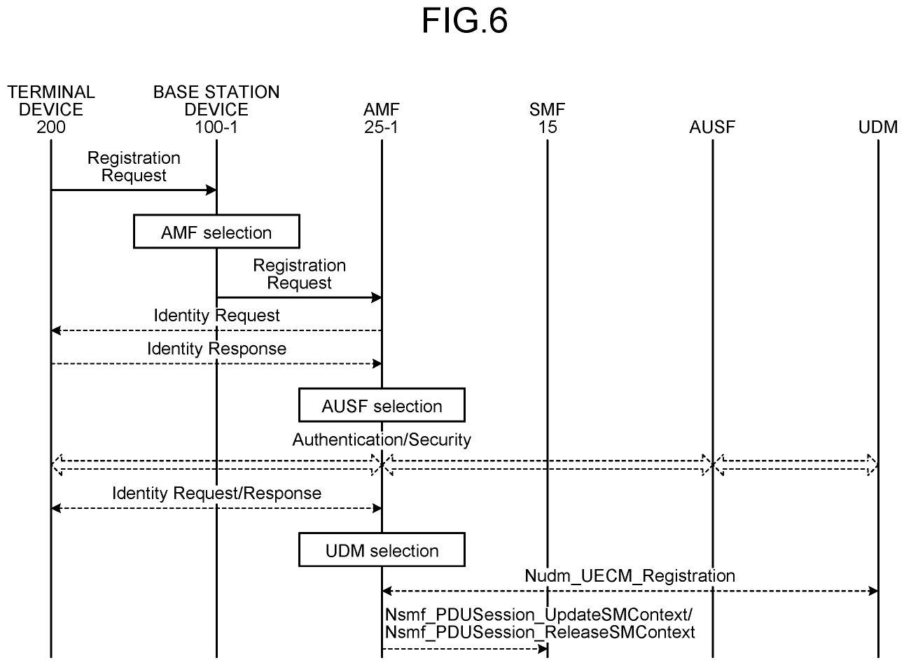

Furthermore, while the case where the UE context is registered by the AMFs 25-1 and 25-2 is described above, a context corresponding to the UE context is also registered in the SMF 15. That is, as illustrated in FIG. 6, for example, when a registration request (Registration Request) is transmitted from the terminal device 200 to the AMF 25-1 via the base station device 100-1, the AMF 25-1 selects AUthentication Server Function (AUSF) and Unified Data Management (UDM). Thereafter, the AMF 25-1 executes update of the context for the SMF 15.

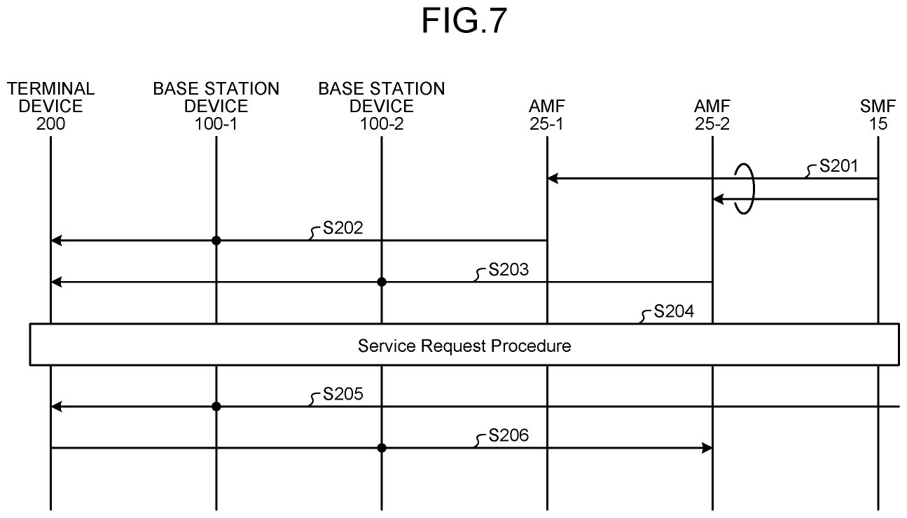

Next, paging processing executed when each of the base station devices 100-1 and 100-2 and the AMFs 25-1 and 25-2 holds the UE context regarding the terminal device 200 will be explained by referring to the sequence chart illustrated in FIG. 7.

When DL data addressed to the terminal device 200 is generated, the SMF 15 transmits a message for notifying generation of the DL data to the AMFs 25-1 and 25-2 in which the UE context of the terminal device 200 is registered, in order to call the terminal device 200 (step S201). That is, since the UE context of the terminal device 200 is registered in both of the AMFs 25-1 and 25-2 in the present embodiment, the SMF 15 notifies generation of DL data that is addressed to the terminal device 200 to the AMFs 25-1 and 25-2.

Upon receiving the notification, the AMF 25-1 executes paging to call the terminal device 200 via the base station device 100-1 (step S202). Similarly, upon receiving the notification, the AMF 25-2 executes paging to call the terminal device 200 via the base station device 100-2 (step S203). As described, since the UE context regarding the terminal device 200 is held in each of the AMFs 25-1 and 25-2 and base station devices 100-1 and 100-2, it is possible to call the terminal device 200 via a plurality of paths, thereby improving the reliability of paging. For example, it is expected to improve the characteristics, such as increasing the likelihood that the terminal device 200 is able to receive the paging and to respond to the paging more quickly.

The terminal device 200 upon receiving the paging starts a service request procedure (Service Request Procedure) (step S204), and selects a path that goes through one of the base station devices 100-1 and 100-2 that have received the paging. That is, since paging messages are received from a plurality of paths going through the base station devices 100-1 and 100-2, the terminal device 200 selects one of the paths. Here, the explanation continues assuming that the path that goes through the base station device 100-1 is selected.

When the path that goes through the base station device 100-1 is selected in the service request procedure, DL data is transmitted from, for example, a User Plane Function (UPF) of the core network through the selected path (step S205). Note that uplink data may also be transmitted and received through the path that goes through the selected base station device 100-1. Furthermore, since the path that goes through the base station device 100-1 is selected, the terminal device 200 may transmit, via the base station device 100-2, a NAS message for requesting deregistration to the AMF 25-2 regarding the unselected path (step S206). In response, in the AMF 25-2, registration of the terminal device 200 is canceled and the UE context is deleted as well. As a result, a U-plane data path that goes through the base station device 100-1 can be uniquely established between the terminal device 200 and the AMF 25-1.

As described, since each of the AMFs 25-1 and 25-2 holds the UE context regarding the terminal device 200, it is possible to execute paging across the tracking areas of both the AMFs 25-1 and 25-2 and to improve the reliability of paging. The terminal device 200 monitors paging for a plurality of paths going through the base station devices 100-1 and 100-2, so that the power consumption of the terminal device 200 increases. Thus, the terminal device 200 may compare the reception levels from the base station devices 100-1 and 100-2 and, when the difference between the reception levels is equal to or more than a prescribed threshold, may monitor the paging only for the path that goes through the base station device with a higher reception level. In this manner, the terminal device 200 can monitor the paging from the more adjacent base station device and reduce the power consumption for monitoring paging.

As described above, according to the present embodiment, when establishing a connection with the base station device, the terminal device can acquire and hold identification information of a UE context from the base station device to be connected even when the terminal device already holds the identification information of the UE context notified from another base station device, the AMF can register a new UE context even when the UE context of the terminal device is already registered in another AMF, and the base station device can notify the identification information of the new UE context even when the terminal device already holds the identification information of the UE context notified from the other base station device. Thus, transfer of the UE context does not occur even when the base station device to be the communication partner of the terminal device is changed or when the terminal device moves across tracking areas under the control of different AMFs. As a result, it is possible to suppress the communication delays of the terminal device and to reduce the processing load caused due to signaling related to the transfer of the UE context. In other words, it is possible to improve the adaptability to various situations.

### c Third Embodiment

In the second embodiment described above, when establishing connection with each of the base station devices 100-1 and 100-2, the terminal device 200 makes registration (for example, location registration) to the AMFs 25-1 and 25-2, respectively. However, when the base station devices 100-1 and 100-2 are connected under a single AMF 25, it is possible to omit registration to the AMF 25. Thus, a third embodiment describes operations of a case where the base station devices 100-1 and 100-2 are connected to a single AMF 25.

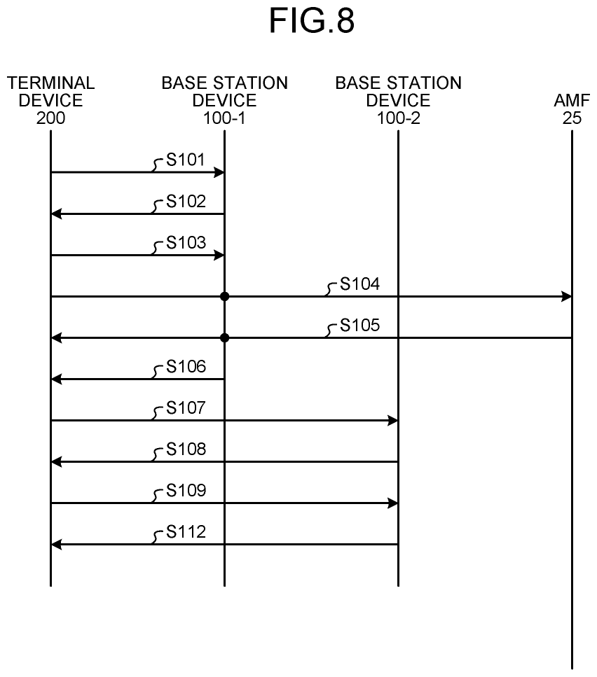

Since the configuration of the wireless communication system and the configurations of the base station device 100 and the terminal device 200 according to the third embodiment are the same as those of the second embodiment (FIGS. 2 to 4), explanations thereof are omitted. FIG. 8 is a sequence chart illustrating an information management method executed in the wireless communication system according to the third embodiment. In FIG. 8, the same reference signs are applied to the same structural components as those of FIG. 5. In the following description, it is assumed that the wireless communication system includes the base station devices 100-1 and 100-2 having the configuration equivalent to that of the base station device 100, and the base station devices 100-1 and 100-2 are both connected under the AMF 25.

When the terminal device 200 establishes communication with the base station device 100-1, an AS message for requesting connection is transmitted from the terminal device 200 to the base station device 100-1 (step S101). Examples of the AS message include an RRC connection request (Connection Request), a connection resume request (Connection Resume Request), and the like.

In response to the AS message, an AS message for prescribed settings is transmitted from the base station device 100-1 to the terminal device 200 (step S102), and an AS message for notifying completion of connection is transmitted from the terminal device 200 to the base station device 100-1 (step S103).

When connection between the terminal device 200 and the base station device 100-1 is established in this manner, a NAS message for registration (for example, location registration) is transmitted from the terminal device 200 to the AMF 25 that has control over the base station device 100-1 via the base station device 100-1 (step S104). When the terminal device 200 is registered by the AMF 25, a NAS message indicating that the registration has been accepted is transmitted from the AMF 25 to the terminal device 200 via the base station device 100-1 (step S105). Thus, the UE context is registered (established) between the AMF 25 and the terminal device 200.

Furthermore, in the base station device 100-1, a UE context regarding the terminal device 200 is generated. Then, temporary identification information including the identification information of the terminal device 200 and the identification information of the base station device 100-1 is generated as the identification information of the UE context. As the temporary identification information, it is possible to use I-RNTI, for example. I-RNTI is 40-bit identification information that can simultaneously identify the terminal device and the base station device.

The generated UE context is held by the base station device 100-1, and the identification information of the UE context is notified to the terminal device 200 by, for example, an AS message for releasing the connection (step S106). Upon receiving the notification, the terminal device 200 holds the identification information of the UE context and releases the connection with the base station device 100-1. At this time, the terminal device 200 may transition to the RRC inactive mode, for example.

Then, the terminal device 200, for example, moves and establishes communication with the base station device 100-2, an AS message for requesting connection is transmitted from the terminal device 200 to the base station device 100-2 (step S107). In response to the AS message, an AS message for prescribed configurations is transmitted from the base station device 100-2 to the terminal device 200 (step S108), and an AS message for notifying completion of connection is transmitted from the terminal device 200 to the base station device 100-2 (step S109).

Here, the base station device 100-2 is connected under the same AMF 25 for the base station device 100-1 that has already notified the identification information of the UE context to the terminal device 200. Thus, when connection with the base station device 100-2 is established, the terminal device 200 omits registration to the AMF 25. Therefore, no NAS messages are transmitted and received between the terminal device 200 and the AMF 25, and a UE context regarding the terminal device 200 is generated in the base station device 100-2. That is, the base station device 100-2 can generate temporary identification information including the identification information of the terminal device 200 and the identification information of the base station device 100-2 as the identification information of the UE context, regardless of whether the terminal device 200 already holds the identification information of the UE context. As the temporary identification information, it is possible to use I-RNTI, for example, like the identification information generated by the base station device 100-1.

The generated UE context is held by the base station device 100-2, and the identification information of the UE context is notified to the terminal device 200 by, for example, an AS message for releasing the connection (step S112). Upon receiving the notification, the terminal device 200 holds the identification information of the UE context and releases the connection with the base station device 100-2. At this time, the terminal device 200 may transition to the RRC inactive mode, for example.

As described, when the terminal device 200 establishes communication with the base station device 100-2, the terminal device 200 acquires and holds the identification information of the UE context from the base station device 100-2 even when the terminal device 200 already holds the identification information of the UE context notified from the base station device 100-1. The base station device 100-2 also generates a new UE context and notifies the identification information of the new UE context even when the terminal device 200 already holds the identification information of the UE context notified from the base station device 100-1. Thus, for example, even when the terminal device 200 in the RRC inactive mode moves from the communication range of the base station device 100-1 to the communication range of the base station device 100-2 and returns to the RRC connected mode, there is no need to transfer the UE context between the base station devices. As a result, it is possible to suppress the communication delays when the terminal device 200 returns to the RRC connected mode and to reduce the processing load caused due to signaling related to the transfer of the UE context. In other words, it is possible to improve the adaptability to various situations.

Furthermore, when the base station devices 100-1 and 100-2 are connected under a single AMF 25, the terminal device 200 makes registration to the AMF 25 via the base station device 100-1, and omits registration to the AMF 25 when establishing connection with the base station device 100-2. Thus, redundant registration can be omitted and the load on the wireless communication system can be reduced.

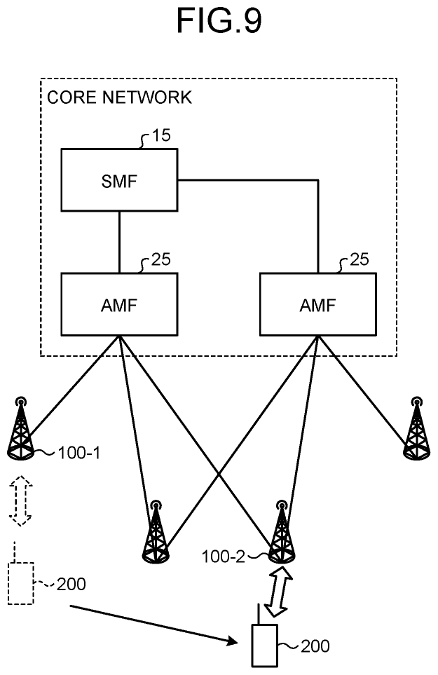

FIG. 9 is a diagram illustrating a specific example of data communication when the terminal device 200 moves. As illustrated in FIG. 9, when the terminal device 200 establishes connection, for example, with, the base station device 100-1 and is registered in the AMF 25, a UE context regarding the terminal device 200 is generated. The terminal device 200 also receives a notification regarding the identification information of the UE context from the base station device 100-1. It is assumed that the terminal device 200 transitions, for example, to the RRC inactive mode within the communication range of the base station device 100-1, and moves to the communication range of the base station device 100-2 during the RRC inactive mode.

Upon returning to the RRC connected mode within the communication range of the base station device 100-2, for example, the terminal device 200 establishes connection with the base station device 100-2. At this time, since the base station device 100-2 is connected under the same AMF 25 for the base station device 100-1, the terminal device 200 omits registration to the AMF 25 and receives a notification regarding the identification information of the UE context from the base station device 100-2. That is, the base station device 100-2 generates and notifies identification information of a new UE context to the terminal device 200 without transferring the UE context to and from the base station device 100-1 to which the terminal device 200 was connected until recently. Then, communication is started between the terminal device 200 and the base station device 100-2. Thus, communication between the terminal device 200 and the base station device 100-2 can be started quickly without transferring the UE context between the base station devices, and the processing load caused due to signaling related to the transfer of the UE context can be reduced.

Furthermore, when the terminal device 200 establishes connection with the base station device 100-2, registration of the terminal device 200 to the AMF 25 is omitted, and thus redundant registration does not occur and the load on the wireless communication system can be reduced.

As described above, according to the present embodiment, when establishing connection with the base station device, the terminal device can acquire and hold the identification information of the UE context from the base station device to be connected anew even when the terminal device already holds the identification information of the UE context notified from another base station device, and the base station device can notify the identification information of the new UE context even when the terminal device already holds the identification information of the UE context notified from the other base station device. Thus, transfer of the UE context does not occur even when the base station device to be the communication partner of the terminal device is changed. As a result, it is possible to suppress the communication delays of the terminal device and to reduce the processing load caused due to signaling related to the transfer of the UE context. In other words, it is possible to improve the adaptability to various situations.

In addition, even when the base station device to be the communication partner is changed, the terminal device omits registration to the AMF as long as the higher-level AMF is not changed. Thus, redundant registration does not occur and the load on the wireless communication system can be reduced.

While downlink communication is explained in each of the above embodiments by referring to the paging processing executed in a case where each of the base station device 100 and the AMF 25 holds the UE context regarding the terminal device 200, it is needless to say that uplink communication may also be performed. When performing uplink communication, communication is started with a request to establish an RRC connection instead of the paging processing.

According to one aspect of the wireless communication device, wireless communication system, and information management method disclosed herein, it is possible to improve the adaptability to various situations.

All examples and conditional language recited herein are intended for pedagogical purposes of aiding the reader in understanding the disclosure and the concepts contributed by the inventors to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A wireless communication device comprising processor circuitry configured to perform to control, when establishing communication with another wireless communication device in a non-communication mode, to generate first identification information included in identification information that is able to simultaneously identify the wireless communication device itself and the other wireless communication device, regardless of whether the other wireless communication device holds second identification information included in the identification information, and to notify the generated first identification information to the other wireless communication device.

2. The wireless communication device according to claim 1, wherein the processor circuitry is further configured to notify the first identification information to the other wireless communication device along with a message for releasing connection with the other wireless communication device.

3. The wireless communication device according to claim 1, wherein the identification information is Inactive-Radio Network Temporary Identifier (I-RNTI) that is capable of simultaneously identifying a pair of wireless communication devices that communicate with each other wirelessly.

4. A wireless communication device comprising processor circuitry configured to perform to control, when establishing communication with another wireless communication device in a non-communication mode, to be notified of, from the other wireless communication device, first identification information included in identification information that is able to simultaneously identify the wireless communication device itself and the other wireless communication device, the first identification information being generated by the other wireless communication device, regardless of whether the wireless communication device itself holds second identification information included in the identification information.

5. The wireless communication device according to claim 4, wherein the processor circuitry is notified of the first identification information from the other wireless communication device along with a message for releasing connection with the other wireless communication device.

6. The wireless communication device according to claim 4, wherein the identification information is Inactive-Radio Network Temporary Identifier (I-RNTI) that is capable of simultaneously identifying a pair of wireless communication devices that communicate with each other wirelessly.

7. A wireless communication system comprising a first wireless communication device and a second wireless communication device, wherein
the first wireless communication device configured to perform to control, when establishing communication with the second wireless communication device in a non-communication mode, to generate first identification information included in identification information that is able to simultaneously identify the first wireless communication device itself and the second wireless communication device, regardless of whether the second wireless communication device holds second identification information included in the identification information, and to notify the generated first identification information to the second wireless communication device, and
the second wireless communication device configured to perform to control, when establishing communication with the first wireless communication device in a non-communication mode, to be notified of, from the first wireless communication device, the first identification information that is generated by the first wireless communication device, regardless of whether the second wireless communication device itself holds second identification information.
